(19) United States
(12) Patent Application Publication
(10) Pub. No.: US 2026/0237053 A1
(43) Pub. Date: Aug. 13, 2026

(54) METHOD FOR PIPELINE DEFECT DETECTION, QUANTIFICATION, AND EVALUATION BASED ON CCTV AND DEEP LEARNING

(71) Applicant: Zhejiang University, Hangzhou (CN)

(72) Inventors: Yiyi MA, Hangzhou (CN); Chenhao YANG, Hangzhou (CN); Tuqiao ZHANG, Hangzhou (CN); Kaiyi TAN, Hangzhou (CN); Jialing LIANG, Hangzhou (CN)

(21) Appl. No.: 19/274,667

(22) Filed: Jul. 21, 2025

(30) Foreign Application Priority Data
Feb. 10, 2025 (CN) 202510143646.3

(51) Int. Cl. G06T 7/00; G06N 3/0464; G06V 10/26; G06V 10/32; G06V 10/80; H04N 7/18

(52) U.S. Cl. CPC G06T 7/0006; G06N 3/0464; G06V 10/273; G06V 10/32; G06V 10/806; H04N 7/18

(57) ABSTRACT

A method for pipeline defect detection, quantification, and evaluation based on CCTV and deep learning includes: constructing an improved pipeline crack recognition model and creating a dataset for training the pipeline crack recognition model; acquiring images from pipeline videos, inputting the acquired images into the pre-trained pipeline crack recognition model, and identifying and segmenting a crack-containing image from the images available; removing redundant pixels from the image, reducing a crack width to a single pixel width, and using a circle detection calculation method to obtain coordinates O(x_{c}, y_{c}) of a cross section center of the pipeline in the crack-containing image, and a plurality of specific pixels Aᵢ(xᵢ, yᵢ) on the pipeline crack in the image; calculating a crack length, morphology, and width of the pipeline crack through a CDQ method; and evaluating severity of the pipeline crack, and repairing the pipeline crack.

### CROSS-REFERENCE TO RELATED APPLICATIONS

The present application claims priority to Chinese Patent Application No. 202510143646.3, filed on Feb. 10, 2025, the entire disclosure of which is incorporated herein by reference.

### TECHNICAL FIELD

The present disclosure relates to a method for pipeline defect detection, quantification, and evaluation based on CCTV and deep learning.

### BACKGROUND

Urban drainage pipelines are one of the most critical underground infrastructures, and are configured for collecting and transporting domestic sewage, industrial wastewater, and urban rainwater. Due to aging, improper operation and maintenance of pipelines, defects such as cracks, deformation, and corrosion are becoming increasingly severe, which easily lead to reduced flow capacity, sewage overflow, water environment pollution, and urban flooding, and even deterioration of internal sanitary conditions of the drainage pipelines. Failure to promptly detect, evaluate, and repair drainage pipeline defects may cause urban economic losses and even endanger the safety of residents' lives and property.

Closed-circuit television (CCTV) has been applied to the inspection of drainage pipelines to detect internal defects and reduce the impact of defects. Although CCTV displays internal conditions of drainage pipelines, inspectors still need to spend a lot of time to search for and evaluate defects from a large number of images, particularly for complex drainage pipelines with poor sanitary conditions.

Inspectors need to evaluate defects according to the latest specifications and develop repair plans. However, due to the broad definitions in drainage pipe specifications, the uniqueness of shooting angles, and the experience differences between inspectors, the defect evaluation process is somewhat subjective. Therefore, it is both important and difficult to develop a method for automatic detection, quantification, and evaluation of drainage pipeline defects.

### SUMMARY

In view of the deficiencies in the prior art, an objective of the present disclosure is to provide a method for pipeline defect detection, quantification, and evaluation based on CCTV and deep learning. The method, in combination with an improved segmentation model and an innovative crack quantification method, enables to characterize basic information such as the crack length, width, and morphology, and preliminarily evaluate defect severity of complex drainage pipelines with poor sanitary conditions.

To achieve the above objective, the present disclosure provides a method for pipeline defect detection, quantification, and evaluation based on CCTV and deep learning, and the method includes the following steps: step 1: constructing an improved pipeline crack recognition model and creating a dataset for training the pipeline crack recognition model;
step 2: acquiring images from pipeline videos, inputting the acquired images into the pre-trained pipeline crack recognition model, and using the pipeline crack recognition model to identify and segment a crack-containing image from the images available;
step 3: removing redundant pixels from the image, reducing a crack width to a single pixel width, and using a circle detection calculation method to obtain coordinates O(x_{c}, y_{c}) of a cross section center of the pipeline in the crack-containing image, and a plurality of specific pixels Aᵢ(xᵢ, yᵢ) on the pipeline crack in the image;
step 4: calculating a crack length, morphology, and width of the pipeline crack through a method for crack length, morphology, and width quantification; and
step 5: evaluating severity of the pipeline crack according to crack severity grading rules and the pipeline crack length and width calculated, and repairing the pipeline crack according to a corresponding crack severity level.

Further, the pipeline crack recognition model includes an optimized backbone network, an optimized ASPP structure, and an optimized decoder, where the optimized backbone network is of a MobileNet V2 structure, an original
image is down-sampled three times, feature information transmission is performed once before either of the last two down-samplings, feature information transmitted for the first time is named as low-level feature information, and feature information transmitted for the second time is mid-level feature information;
feature information transmitted through the optimized ASPP structure is named as high-latitude feature information; the optimized ASPP structure includes four convolution blocks with different dilation rates, one global average pooling module, and a depthwise separable convolution module; the optimized decoder receives the low-level feature information, the mid-level feature information, and the high-level feature information, simultaneously adopts the depthwise separable convolution module in the optimized decoder, fuses the low-level feature information, the mid-level feature information, and the high-level feature information in a hierarchical concatenation layer, and restores a fused image to form a segmented image of the same size as an input image.

Further, the method for crack morphology quantification in the step 4 specifically includes the following steps:
(1) unfolding the pipeline into a rectangle, where a bottom edge H-H′ of the pipeline is equal to a bottom side of the rectangle in length, scanning in a length direction of the pipeline to obtain a plurality of pixels Aᵢ(xᵢ, yᵢ), where A₁(x₁, y₁) is a first pixel detected on the pipeline crack in the image, and converting A₁(x₁, y₁) and O(x_{c}, y_{c}) through length scaling to calculate an arc length from a bottom of the pipeline to a pixel A₁, i.e., calculating through the formula

$${Y}_{A 1} = \frac{{γ}_{A 1}}{360} \times 2 π {R}_{s}$$

(Rₛ is an actual radius of cross section of the pipeline);
where

$${γ}_{A 1} = \frac{{rad}_{A 1} \times 180}{π}$$

is a degree expression of an angle rad_{A1};

$${rad}_{A 1} = arc cos ( \frac{\vec{{A}_{1} O} \cdot \vec{HO}}{‖ \vec{{A}_{1} O} ‖ \times ‖ \vec{H O} ‖} )$$

is an included angle between A₁-O and H-O;
(2) since the pixel A is treated as a reference point for reconstructing a pipeline crack morphology, an X coordinate of A in an actual rectangular domain is denoted as X=0, that is, a coordinate system of the pixel A in the actual rectangular domain is (0, Y_{A1});
(3) sequentially calculating all pixels on the pipeline crack in the image according to the calculation formula in the step (1) to obtain a Y coordinate Y_{Ai};
then, calculating the X coordinate Xa for all pixels on the pipeline crack in the actual rectangular domain, and specifically calculating through the following formula:

$${X}_{A 2} = \frac{{R}_{s}}{\sqrt{{( {y}_{2} - {y}_{c} )}^{2} + {( {x}_{2} - {x}_{c} )}^{2}}} \times 1 pixel ,$$

a horizontal distance between adjacent pixels corresponds to an actual length of a single pixel; and
(4) obtaining coordinates (X_{Ai}, Y_{Ai}) of all pixels A on the pipeline crack in the actual rectangular domain through the step (3); and drawing the morphology of the pipeline crack in the actual rectangular domain according to the coordinates obtained, and then transferring the pipeline crack on a pipeline wall from a curved surface to a plane for morphology reconstruction.

Further, the method for crack width quantification in the step 4 specifically includes the following steps: randomly drawing a plurality of inscribed circles inside the pipeline crack, and taking a diameter of the largest inscribed circle as the pipeline crack width w.

Further, the method for crack length quantification in the step 4 specifically includes the following steps:
(1) based on the coordinates O(x_{c}, y_{c}) of the cross section center of the pipeline in the crack-containing image, and the plurality of specific pixels Aᵢ(xᵢ, yᵢ) on the pipeline crack in the image, calculating an actual length of each pixel on the pipeline crack, where the actual length of each pixel is calculated through the following formula:

$${λ}_{i} = \frac{{C}_{s}}{{C}_{i}} = \frac{{R}_{s}}{\sqrt{{( {y}_{i} - {y}_{c} )}^{2} + {( {x}_{i} - {x}_{c} )}^{2}}}$$

where λᵢ is the actual length of each pixel, Cᵢ is a circumference of a new circle centered at a point O with a radius OAᵢ, Cₛ is an actual circumference of cross section of the pipeline, and Rₛ is an actual radius of cross section of the pipeline;
(2) after calculating the actual length of each pixel, calculating a total length of the entire crack by summing, where the summation formula is as follows:

$$L = α {\sum }_{i = 1}^{N} {L}_{i}$$

where Lᵢ equals λᵢ, i.e., the actual length of each pixel, α is a correction factor, and when a resolution is 1080 P or 480 P, a is 1.2 or 1.8.

Further, in a verification process of crack length and width quantification, a mean square error (MSE) is introduced, and calculated according to the formula

$$M S E = \frac{1}{N} {\sum }_{i = 1}^{N} {( {observed}_{i} - {predicted}_{i} )}^{2} ;$$

where N is the total number of morphological cracks of a same length, observed; is an actual value of each crack, and predicted, is a predicted value of each crack.

Further, the pipeline crack severity grading rules in the step 5 as specifically as follows: cracks are divided into four grades, including: Grade I cracks, with lengths within a range of 0-200 mm and/or widths within a range of 0-0.2 mm, where repair of the Grade I cracks is not required;
Grade II cracks, with lengths within a range of 200-300 mm and/or widths within a range of 0.2-2.0 mm, where the Grade II cracks are repaired through a trenchless repair method;
Grade III cracks, with lengths within a range of 300-400 mm and/or widths within a range of 2.0-5.0 mm, where the Grade III cracks are repaired through the trenchless repair method or a conventional excavation method;
Grade IV cracks, with lengths of >400 mm and/or widths of >5.0 mm, where pipeline replacement is required due to severity of the Grade IV cracks; and
when evaluation results indicate that a crack belongs to different grades classified by a length and a width thereof respectively, the higher grade is regarded as the final grade determined.

An electronic device includes: a memory and a processor, where the memory is configured to store computer-executable instructions, the processor is configured to execute the computer-executable instructions, and when the computer-executable instructions are executed by the processor, steps of the method for pipeline defect detection, quantification, and evaluation based on CCTV and deep learning are implemented.

A computer-readable storage medium is provided, which stores computer-executable instructions, and when the computer-executable instructions are executed by the processor, steps of the method for pipeline defect detection, quantification, and evaluation based on CCTV and deep learning are implemented.

Beneficial effects: 1. In the present disclosure, the pipeline crack recognition model is improved, including the optimized backbone network, the optimized ASPP structure, and the optimized decoder, and more detailed features are extracted, including the overall morphology of defects such as pipeline cracks, such that the model learns more feature information from more scales, thereby improving the accuracy of the segmentation model.

2. The present disclosure further provides the method for crack length, morphology, and width quantification, which, in combination with the pipeline crack recognition model, enhances the detection and evaluation of cracks, and enables to characterize basic information such as crack length, width, and morphology, and preliminarily evaluate defect severity of complex drainage pipelines with poor sanitary conditions. The present disclosure not only improves the efficiency and accuracy of crack detection, but also facilitates large-scale applications and improves the accuracy of pipeline defect detection, quantification, and evaluation.

### BRIEF DESCRIPTION OF THE DRAWINGS

FIG. 1 is a schematic diagram of steps of a method for pipeline defect detection, quantification, and evaluation based on CCTV and deep learning.

FIG. 2 is a structural diagram of an optimized DeepLab V3 Plus Pro network structure.

FIG. 3 is a structural diagram of an optimized backbone network structure.

FIG. 4 is a structural diagram of an optimized ASPP structure.

FIG. 5 is a structural diagram of an optimized decoder.

FIG. 6 is a schematic diagram of acquiring a single-width crack.

FIG. 7 is a schematic diagram of crack morphology quantification.

FIG. 8 is a schematic diagram of crack width quantification.

FIG. 9 is a partial schematic diagram of an experimental dataset.

FIG. 10 is a partial schematic diagram of an actual dataset.

FIG. 11 is a schematic diagram of a crack recognition case from an experimental dataset.

FIG. 12 is a data graph of accuracy results of a CDQ algorithm with different semantic segmentation models under an experimental dataset.

FIG. 13 is a schematic diagram of a crack quantification case from an experimental dataset.

FIG. 14 is a schematic diagram of a crack recognition case from an actual dataset.

FIG. 15 is a data graph of accuracy results of a CDQ algorithm with different semantic segmentation models under an actual dataset.

FIG. 16 is a schematic diagram of a crack quantification case from an actual dataset.

### DETAILED DESCRIPTIONS OF THE EMBODIMENTS

In order to further describe the technical means adopted by the present disclosure to achieve intended objectives and also the effects, specific embodiments, structure, features, and effects of the present disclosure are described in detail below with reference to the accompanying drawings and preferred examples.

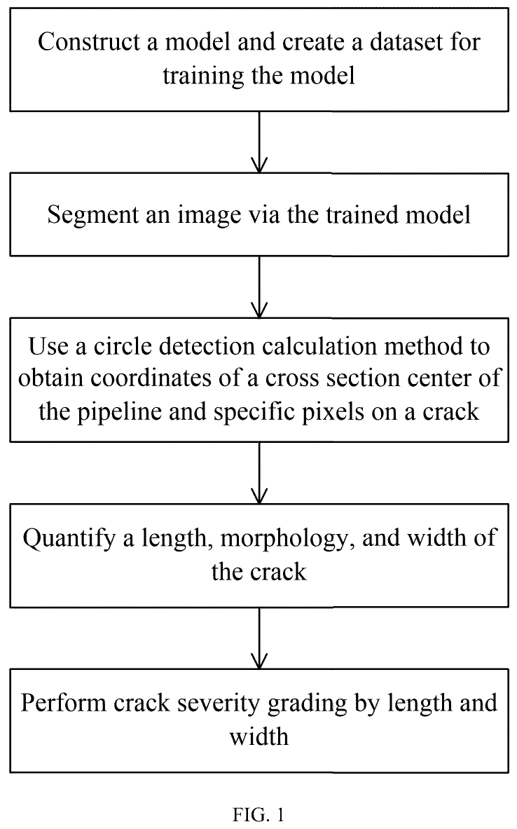

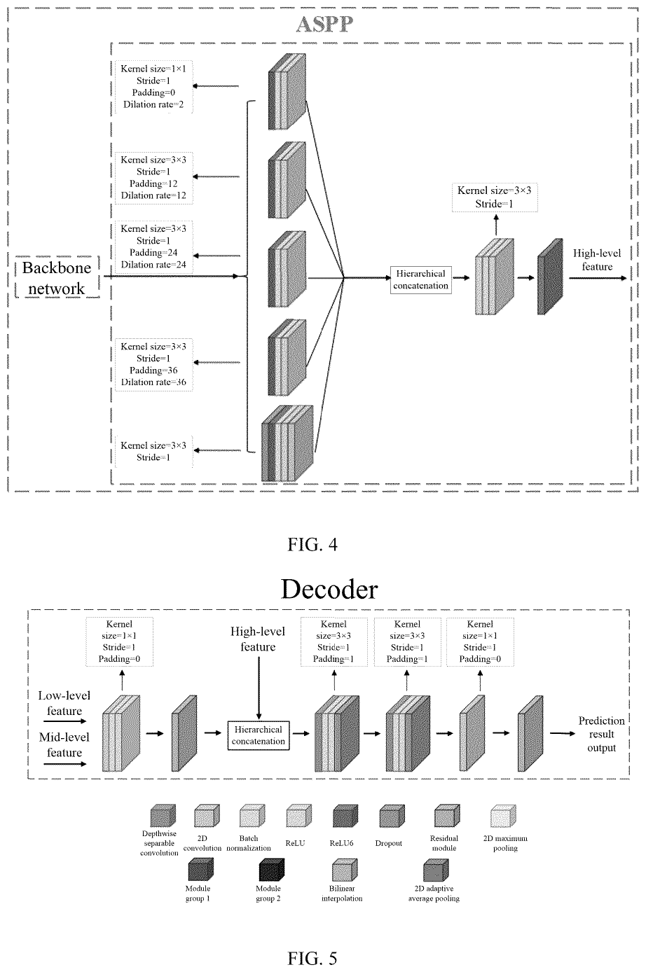

With reference to FIGS. 1-16, the present disclosure provides a method for pipeline defect detection, quantification, and evaluation based on CCTV and deep learning, and a dataset is created for training a pipeline crack recognition model, where the dataset includes an experimental dataset and an actual dataset, as detailed below:

### The Experimental Dataset

Images generated by simulating cracks with a black tape in a laboratory are shown in FIG. 9. A training dataset includes images of cracks of different widths, lengths, and morphologies taken at random shooting angles. A validation dataset includes images illustrating cracks of two different widths (2 mm and 8 mm) and two different lengths (80 mm and 150 mm) designed to simulate cracks of Grade II and Grade IV. Five different forms of cracks are artificially created, including: vertical linear cracks, vertical undulating cracks, inclined cracks, horizontal linear cracks, and horizontal undulating cracks. A total of 45 images are used for training; and 30 images are used for validation. In order to improve the accuracy of a segmentation model and avoid data leakage, the number of images in the training dataset is increased to 270 through geometric transformations, and specific operations include rotation, width translation, height translation, shearing, and scaling. Since an internal environment of the pipeline is clear and image resolutions are high, 300 images are sufficient to train the segmentation model.

### The Actual Dataset

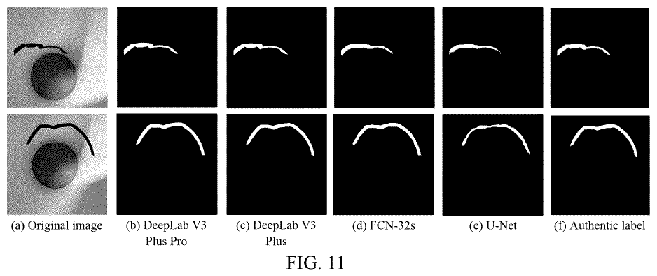

A total of 214 actual CCTV inspection images containing cracks are derived from a Sewer-ML dataset and a pipeline inspection project in a certain region of China, as shown in FIG. 10. The actual dataset is used to verify the performance of a CDQ method in more complex environments than laboratory conditions. In these datasets, 139 images (109 images from China; and 30 images from Sewer-ML) are used for training, and 75 images (55 images from China; and 20 images from Sewer-ML) are used for verification. Similarly, the number of images in the training dataset is increased to 770 through the geometric transformations.

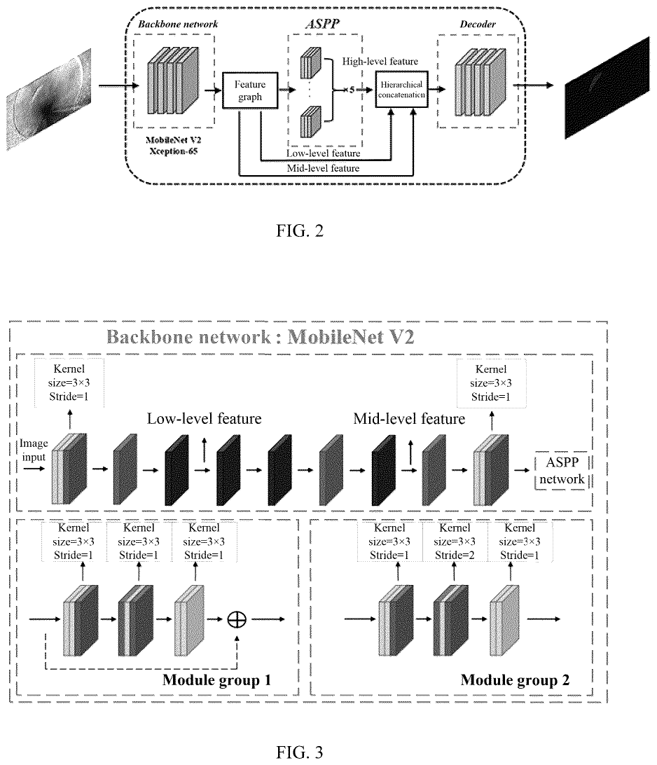

As shown in FIGS. 2-5, an improved pipeline crack recognition model is constructed, and the model is named as the DeepLab V3 Plus Pro model, and is trained based on the above dataset. The pipeline crack recognition model includes an optimized backbone network, an optimized ASPP structure, and an optimized decoder;
the optimized backbone network is of a MobileNet V2 structure, an original image is down-sampled three times, feature information transmission is performed once before either of the last two down-samplings, feature information transmitted for the first time is named as low-level feature information, and feature information transmitted for the second time is mid-level feature information. Specifically, the MobileNet V2 structure includes four module groups 1 and three module groups 2 alternately arranged, where each of the module groups 1 has a residual module, which enables to extract features from images stably and efficiently, and each of the module groups 2 implements a single feature downsampling process and achieves more refined feature extraction. The low-level feature information and the mid-level feature information respectively include the overall morphology of defects such as pipeline cracks and also more detailed features, such that the model learns more feature information from more scales, thereby improving the accuracy of the segmentation model.

Feature information transmitted through the optimized ASPP structure is named as high-level feature information; the optimized ASPP structure includes four convolution modules with different dilation rates, one global average pooling module, and a depthwise separable convolution module; the convolution modules with different dilation rates provide more feature information at different scales, the global average pooling module enables to extract global scale features; and since the backbone network transmits a large number of feature parameters, the depthwise separable convolution module in ASPP achieves the effect of simplifying parameters instead of compromising the model accuracy, thereby realizing efficient calculation. The high-level feature information contains very detailed defect edge features, and is configured for refined learning of defects by the model.

The optimized decoder receives the low-level feature information, the mid-level feature information, and the high-level feature information, simultaneously adopts the depthwise separable convolution module in the optimized decoder, fuses the low-level feature information, the mid-level feature information, and the high-level feature information in a hierarchical concatenation layer, and restores a fused image to form a segmented image of the same size as an input image.

The model further employs a cross entropy loss function, and the cross entropy loss function demonstrates robust performance and is commonly used in CNN-based models. Additionally, a Warm Up method is introduced to minimize initial overfitting and stabilize a deep architecture of the calculation method, so as to better refine the segmentation of crack edges. The model is trained and validated on a Windows system equipped with an AMD EPYC 9534 processor and two NVIDIA Geforce RTX A6000 GPUs with a memory of 48 G. The batch size and learning rate are set to 32 and 0.0001 respectively. Results indicate that the mIoU of the model proposed herein is 0.97, and a trained segmentation model is obtained through dataset training.

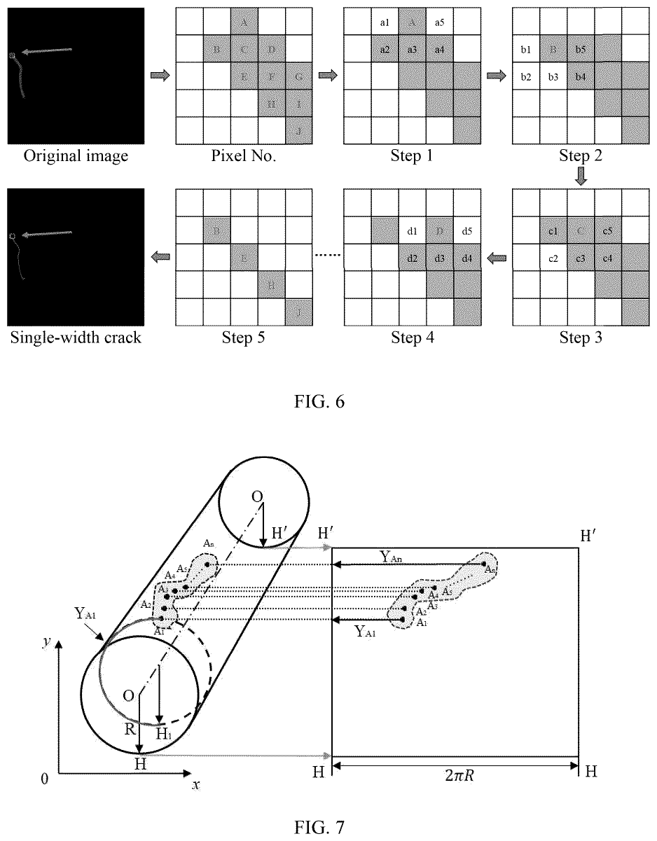

As shown in FIGS. 6-8, images are acquired from pipeline videos, the acquired images are input into the pre-trained pipeline crack recognition model, and the pipeline crack recognition model is used to identify and segment a crack-containing image from the images available. The crack-containing image is marked through a circle detection method, and specifically pixels excluded from counting are removed from the crack-containing image. When there are at least three non-zero pixels directly left, directly right, directly below, lower-left, and lower-right to a pixel, or all pixels on the left and right sides of a pixel are zero, a value of the pixel is set to zero. An edge detection calculation method is used to mark fitting points. Three fitting points are selected to create a circle (x_{c}, y_{c}, r_{c}). This circle is reflected in a three-dimensional coordinate system to show the possibility that the target circle is located at (x_{c}, y_{c}), which is used to obtain coordinates O(x_{c}, y_{c}) of a cross section center of the pipeline in the crack-containing image, and a plurality of specific pixels Aᵢ(xᵢ, yᵢ) on the pipeline crack in the image, followed by quantification of crack length, morphology and width.

Specific steps for crack length quantification include:
(1) based on the coordinates O(x_{c}, y_{c}) of the cross section center of the pipeline in the crack-containing image, and the plurality of specific pixels Aᵢ(xᵢ, yᵢ) on the pipeline crack in the image, calculate an actual length of each pixel on the pipeline crack, where the actual length of each pixel is calculated through the following formula:

$${λ}_{i} = \frac{{C}_{s}}{{C}_{i}} = \frac{{R}_{s}}{\sqrt{{( {y}_{i} - {y}_{c} )}^{2} + {( {x}_{i} - {x}_{c} )}^{2}}}$$

where λᵢ is the actual length of each pixel, Cᵢ is a circumference of a new circle centered at a point O with a radius OAᵢ, Cₛ is an actual circumference of cross section of the pipeline, and R is an actual radius of cross section of the pipeline;
(2) after calculating the actual length of each pixel, calculate a total length of the entire crack by summing, where the summation formula is as follows:

$$L = α {\sum }_{i = 1}^{N} {L}_{i}$$

where Lᵢ equals λᵢ, i.e., the actual length of each pixel, a is a correction factor used to consider a possible error in the image resolution, and when a resolution is 1080 P or 480 P, a is 1.2 or 1.8.

Specific steps for crack morphology quantification include:
(1) unfold the pipeline into a rectangle, where a bottom edge H-H′ of the pipeline is equal to a bottom side of the rectangle in length, scan in a length direction of the pipeline to obtain a plurality of pixels Aᵢ(xᵢ, yᵢ), where A₁(x₁, y₁) is a first pixel detected on the pipeline crack in the image, and convert A₁(x₁, y₁) and O(x_{c}, y_{c}) through length scaling to calculate an arc length from a bottom of the pipeline to a pixel A₁, i.e., calculate through the formula

$${Y}_{A 1} = \frac{{γ}_{A 1}}{360} \times 2 π {R}_{s} ;$$

where

$${γ}_{A 1} = \frac{r a {d}_{A 1} \times 180}{π} ,$$

an angle rad_{A1} is converted into a degree form, and the angle rad_{A1} is an included angle between A₁-O and H-O calculated through

$$ra {d}_{A 1} = arccos ( \frac{\overline{{A}_{1} O} \cdot \overline{HO}}{‖ \overline{{A}_{1} O} ‖ \times ‖ \overline{HO} ‖} ) ;$$

Rₛ is an actual radius of cross section of the pipeline;
(2) since the pixel A is treated as a reference point for reconstructing a pipeline crack morphology, an X coordinate of A in an actual rectangular domain is denoted as X_{A1}=0, that is, a coordinate system of the pixel A in the actual rectangular domain is (0, Y_{A1});
(3) sequentially calculate all pixels on the pipeline crack in the image according to the calculation formula in the step (1) to obtain a Y coordinate Y_{A1};
then, calculate the X coordinate X_{A1} for all pixels on the pipeline crack in the actual rectangular domain, and specifically calculate through the following formula:

$${X}_{A 2} = \frac{{R}_{i}}{\sqrt{{( {y}_{2} - {y}_{c} )}^{2} + {( {x}_{2} - {x}_{c} )}^{2}}} \times 1 pixel ,$$

a horizontal distance between adjacent pixels corresponds to an actual length of a single pixel; and

(4) obtain coordinates (X_{Ai}, Y_{Ai}) of all pixels A; on the pipeline crack in the actual rectangular domain through the step (3); and draw the morphology of the pipeline crack in the actual rectangular domain according to the coordinates obtained, and then transfer the pipeline crack on a pipeline wall from a curved surface to a plane for morphology reconstruction.

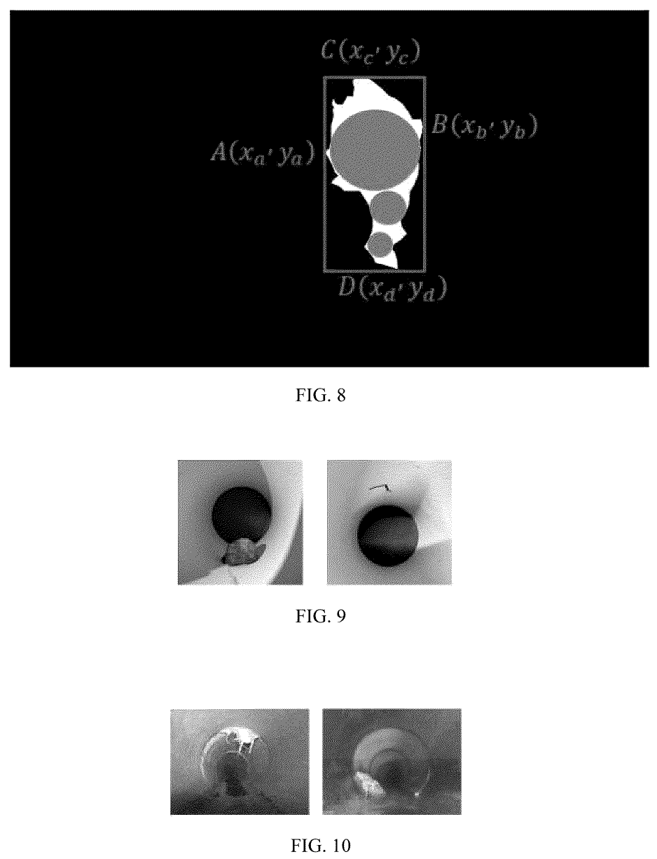

Specific steps for crack width quantification include: randomly draw inscribed circles inside the pipeline crack, as indicated by circles in FIG. 8. A diameter of the largest inscribed circle among these inscribed circles is taken as the pipeline crack width w.

The above method for calculating the pipeline crack length, morphology, and width is called a crack detection and quantification method (CDQ).

Pipeline cracks are identified and quantified based on the experimental dataset, and the DeepLab V3 Plus Pro crack recognition model for the CDQ method of the present disclosure is compared with other different crack recognition models in performance, including DeepLab V3 Plus, FCN-32s, and U-Net. Results of prediction through other models are not accurate enough at the pipeline cracks, and the DeepLab V3 Plus Pro model exhibits superior performance, as shown in FIG. 11 and Table 1.

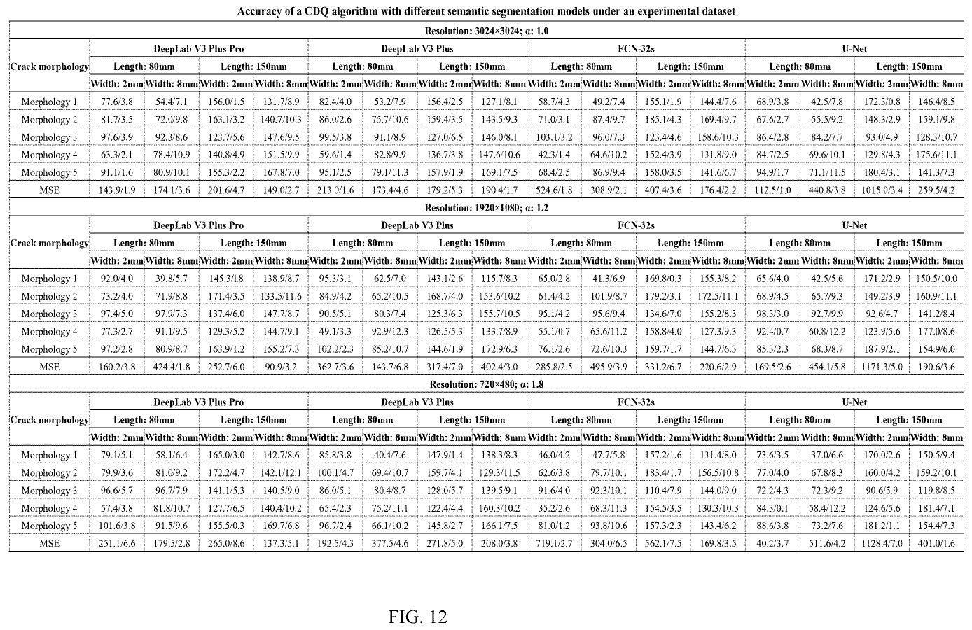

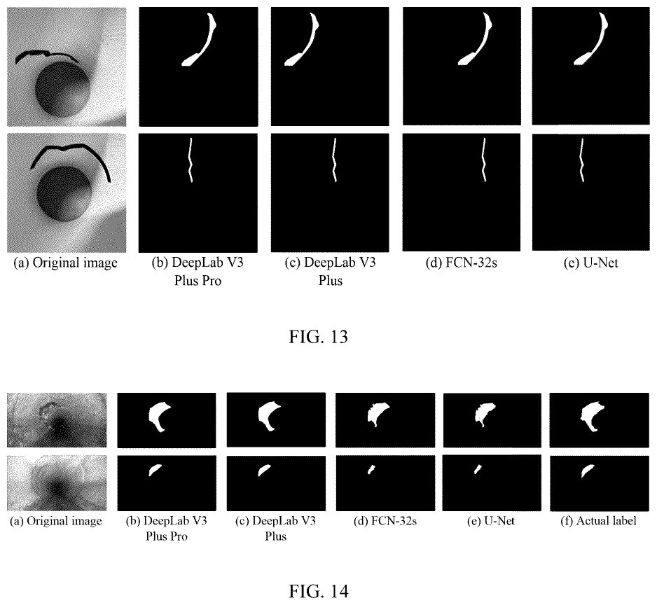

In quantification validation, in order to evaluate the accuracy of the CDQ method in crack quantification, a mean square error (MSE) is introduced, and calculated according to the following formula:

$$MSE = \frac{1}{N} {\sum }_{i = 1}^{N} {( {observed}_{i} - {predicted}_{i} )}^{2}$$

where N is the total number of morphological cracks of a same length, observed; is an actual value of each crack, and predicted; is a predicted value of each crack calculated through the CDQ method. Regarding the CDQ performance, as shown in FIG. 12, results demonstrate that the performance of CDQ is satisfactory, and the MSE is 96.8/1.1, which is used for the quantization of crack length and width. For the correction factor, several common CCTV resolutions (as shown in FIG. 12) are used for experiments. The results indicate that the CDQ method performs optimally at resolutions of 1920×1080 and 720×480 when a is 1.2 or 1.8. Exemplary results of morphology quantization are shown in FIG. 13.

In the experiment of model training based on the actual dataset, verification results of the four detection models based on the actual dataset are shown in FIG. 14 and Table 1, demonstrating that the detection accuracy mIoU of the model of the present disclosure is higher than that of other models, indicating superior performance of the model of the present disclosure in defect segmentation.

TABLE 1
Accuracy of the DeepLab V3 Plus Pro crack recognition
model under the experimental dataset

| | IoU | | | PA | | |
|---|---|---|---|---|---|---|
| | Crack | Obstacle | mIoU | Crack | Obstacle | mPA |
| DeepLab V3 Plus | 59.55 | 83.52 | 71.54 | 78.79 | 90.94 | 84.87 |
| Pro | | | | | | |
| DeepLab V3 Plus | 59.55 | 81.86 | 70.71 | 73.02 | 91.63 | 82.33 |
| FCN-32s | 28.50 | 64.60 | 46.55 | 66.60 | 77.80 | 72.20 |
| U-Net | 34.90 | 52.50 | 43.70 | 54.10 | 80.00 | 67.05 |

To further validate the performance of the CDQ method in crack size quantification, 30 real CCTV inspection images are selected from the validation dataset. Based on the quantification results in the experimental dataset, the correction factor α is set to 1.2 to account for the high resolution of these images (1920×1080 pixels). A diameter of sewer pipeline in these images is 600 mm, and a size of the pipeline crack is calculated on this basis.

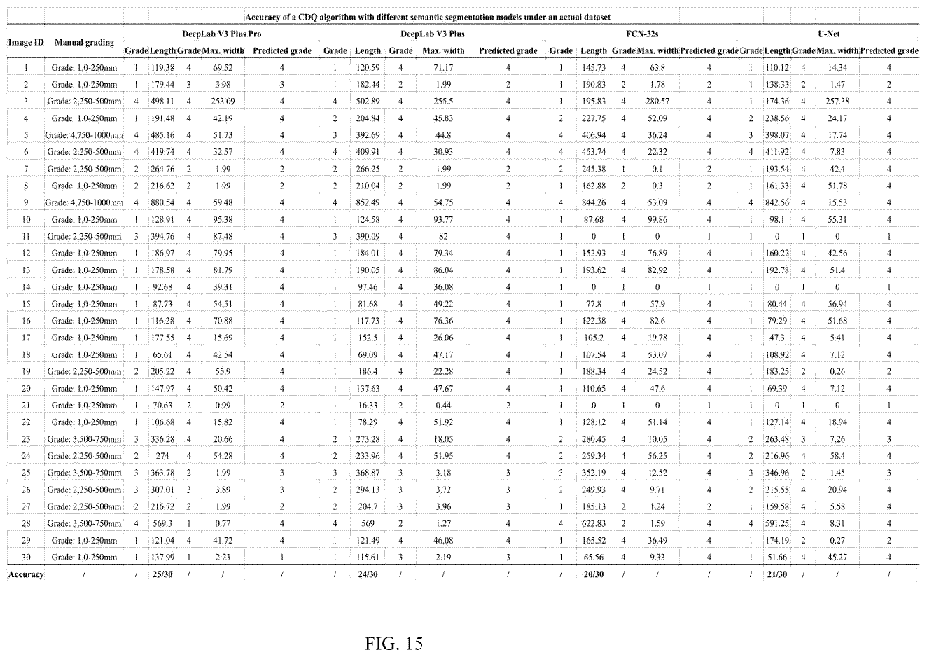

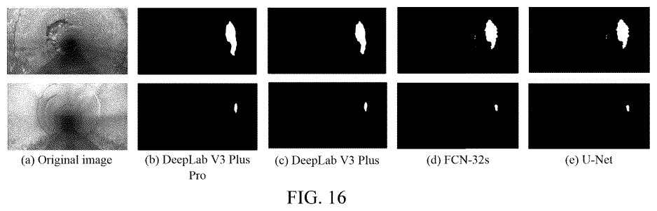

The results of crack size quantification are shown in FIG. 15. This indicates that compared to FCN-32s and U-Net, the combination of CDQ with DeepLab V3 Plus Pro achieves better performance in crack length quantification, and 25 out of 30 cracks are properly classified (accuracy of 83%). An example of crack morphology recognition through the CDQ method is shown in FIG. 16. The results show that the combination of the CDQ method with DeepLab V3 Plus Pro achieves satisfactory performance in crack morphology characterization.

Based on length and width quantitation data, the present disclosure provides a method for crack evaluation based on the pipeline crack length and width, and the length and width evaluation method is shown in Table 2.

TABLE 2
Crack grade evaluation method

| | |
|---|---|
| Length | Width |

| | | | |
|---|---|---|---|
| Grade | Value | Grade | Value |

| | | | | | |
|---|---|---|---|---|---|
| 1 | 0-200 | mm | 1 | 0-0.2 | mm |
| 2 | 200-300 | mm | 2 | 0.2-2.0 | mm |
| 3 | 300-400 | mm | 3 | 2.0-5.0 | mm |
| 4 | >400 | mm | 4 | >5.0 | mm |

Cracks are divided into four grades, including: Grade I cracks, with lengths within a range of 0-200 mm and/or widths within a range of 0-0.2 mm, where repair of the Grade I cracks is not required; Grade II cracks, with lengths within a range of 200-300 mm and/or widths within a range of 0.2-2.0 mm, where the Grade II cracks are repaired through a trenchless repair method; Grade III cracks, with lengths within a range of 300-400 mm and/or widths within a range of 2.0-5.0 mm, where the Grade III cracks are repaired through the trenchless repair method or a conventional excavation method; Grade IV cracks, with lengths of >400 mm and/or widths of >5.0 mm, where pipeline replacement is required due to severity of the Grade IV cracks; and
when evaluation results indicate that a crack belongs to different grades classified by a length and a width thereof respectively, the higher grade is regarded as the final grade determined. When evaluation results indicate that a crack belongs to different grades classified by a length and a width thereof respectively, the higher grade is regarded as the final grade determined. For example, a crack with a length of 240 mm and a width of 6 mm is determined as a Grade IV crack. This evaluation method takes into account both the pipeline crack length and the maximum width, enabling more comprehensive evaluation of crack severity.

The present disclosure further provides an electronic device, and the electronic device includes: a memory and a processor, where the memory is configured to store computer-executable instructions, the processor is configured to execute the computer-executable instructions, and when the computer-executable instructions are executed by the processor, steps of the method for pipeline defect detection, quantification, and evaluation based on CCTV and deep learning are implemented.

A computer-readable storage medium is further provided, which stores computer-executable instructions, and when the computer-executable instructions are executed by the processor, steps of the method for pipeline defect detection, quantification, and evaluation based on CCTV and deep learning are implemented.

The foregoing descriptions are merely preferred examples of the present disclosure, and are not intended to impose any formal restrictions on the present disclosure. Although the present disclosure has been disclosed in preferred examples, they are not intended to limit the present disclosure. Without departing from the scope of the technical solution of the present disclosure, any person skilled in the art may make many possible changes to the technical solution by using the above disclosed technical contents, or modify the technical solution into equivalent examples with equivalent changes. Therefore, any simple alterations, equivalent changes and modifications which are made to the above examples in accordance with the technical essence of the present disclosure without departing from the contents of the technical solution of the present disclosure all fall within the scope of protection of the technical solution of the present disclosure.

What is claimed is:

1. A method for pipeline defect detection, quantification, and evaluation based on CCTV and deep learning, comprising:
step 1: constructing an improved pipeline crack recognition model and creating a dataset for training the pipeline crack recognition model, wherein the pipeline crack recognition model comprises an optimized backbone network, an optimized ASPP structure, and an optimized decoder;
the optimized backbone network is of a MobileNet V2 structure, an original image is down-sampled three times, feature information transmission is performed once before either of the last two down-samplings, feature information transmitted for the first time is named as low-level feature information, and feature information transmitted for the second time is mid-level feature information;
feature information transmitted through the optimized ASPP structure is named as high-level feature information; the optimized ASPP structure comprises four convolution modules with different dilation rates, one global average pooling module, and a depthwise separable convolution module;
the optimized decoder receives the low-level feature information, the mid-level feature information, and the high-level feature information, adopts the depthwise separable convolution module in the optimized decoder, fuses the low-level feature information, the mid-level feature information, and the high-level feature information in a hierarchical concatenation layer, and restores a fused image to form a segmented image of the same size as an input image;
step 2: acquiring images from pipeline videos, inputting the acquired images into the pre-trained pipeline crack recognition model, and using the pipeline crack recognition model to identify and segment a crack-containing image from the images available;
step 3: removing redundant pixels from the image, reducing a crack width to a single pixel width, and using a circle detection calculation method to obtain coordinates O(x_{c}, y_{c}) of a cross section center of the pipeline in the crack-containing image, and a plurality of specific pixels Aᵢ(xᵢ, yᵢ) on a pipeline crack in the image;
step 4: calculating a crack length, morphology, and width of the pipeline crack through a method for crack length, morphology, and width quantification; and the method for crack morphology quantification comprises the following steps:
(1) unfolding a pipeline into a rectangle, wherein a bottom edge H-H′ of the pipeline is equal to a bottom side of the rectangle in length, scanning in a length direction of the pipeline to obtain a plurality of pixels Aᵢ(xᵢ, yᵢ), wherein A₁(x₁, y₁) is a first pixel detected on the pipeline crack in the image, and converting A₁(x₁, y₁) and O(x_{c}, y_{c}) through length scaling to calculate an arc length from a bottom of the pipeline to a pixel A₁, i.e., calculating through the formula
$${Y}_{A 1} = \frac{{γ}_{A 1}}{360} \times 2 π {R}_{s} ;$$
in the formula,
$${γ}_{A 1} = \frac{r a {d}_{A 1} \times 180}{π}$$
is a degree expression of an angle rad_{A1};
$$ra {d}_{A 1} = arccos ( \frac{\overline{{A}_{1} O} \cdot \overline{HO}}{‖ \overline{{A}_{1} O} ‖ \times ‖ \overline{HO} ‖} )$$
is an included angle between A₁-O and H-O;
Rₛ is an actual radius of cross section of the pipeline;
(2) since the pixel A is treated as a reference point for reconstructing a pipeline crack morphology, an X coordinate of A in an actual rectangular domain is denoted as X_{A1}=0, that is, a coordinate system of the pixel A in the actual rectangular domain is (0, Y_{A1});
(3) sequentially calculating all pixels on the pipeline crack in the image according to the calculation formula in the step (1) to obtain a Y coordinate Y_{A1};
then, calculating the X coordinate X_{A1} for all pixels on the pipeline crack in the actual rectangular domain, and specifically calculating through the following formula:
$${X}_{A 2} = \frac{{R}_{i}}{\sqrt{{( {y}_{2} - {y}_{c} )}^{2} + {( {x}_{2} - {x}_{c} )}^{2}}} \times 1 pixel ,$$
a horizontal distance between adjacent pixels corresponds to an actual length of a single pixel; and
(4) obtaining coordinates (X_{Ai}, Y_{Ai}) of all pixels Aᵢ on the pipeline crack in the actual rectangular domain through the step (3); and drawing the morphology of the pipeline crack in the actual rectangular domain according to the coordinates obtained, and then transferring the pipeline crack on a pipeline wall from a curved surface to a plane for morphology reconstruction;
step 5: evaluating severity of the pipeline crack according to crack severity grading rules and pipeline crack length and width calculated, and repairing the pipeline crack according to a corresponding crack severity level.

2. The method for pipeline defect detection, quantification, and evaluation based on CCTV and deep learning according to claim 1, wherein the method for crack width quantification in the step 4 comprises the following steps: randomly drawing a plurality of inscribed circles inside the pipeline crack, and taking a diameter of the largest inscribed circle as the pipeline crack width w.

3. The method for pipeline defect detection, quantification, and evaluation based on CCTV and deep learning according to claim 2, wherein the method for crack length quantification in the step 4 comprises the following steps:
(1) based on the coordinates O(x_{c}, y_{c}) of the cross section center of the pipeline in the crack-containing image, and the plurality of specific pixels Aᵢ(xᵢ, yᵢ) on the pipeline crack in the image, calculating an actual length of each pixel on the pipeline crack, wherein the actual length of each pixel is calculated through the following formula:
$${λ}_{i} = \frac{{C}_{s}}{{C}_{i}} = \frac{{R}_{s}}{\sqrt{{( {y}_{i} - {y}_{c} )}^{2} + {( {x}_{i} - {x}_{c} )}^{2}}}$$
in the formula, λᵢ is the actual length of each pixel, Cᵢ is a circumference of a new circle centered at a point O with a radius OAᵢ, Cₛ is an actual circumference of cross section of the pipeline, and Rₛ is an actual radius of cross section of the pipeline;
(2) after calculating the actual length of each pixel, calculating a total length of the entire crack by summing, wherein the summation formula is as follows:
$$L = α {\sum }_{i = 1}^{N} {L}_{i} ;$$
in the formula, Lᵢ equals λᵢ, i.e., the actual length of each pixel, a is a correction factor, and when a resolution is 1080 P or 480 P, α is 1.2 or 1.8.

4. The method for pipeline defect detection, quantification, and evaluation based on CCTV and deep learning according to claim 3, wherein in a verification process of crack length and width quantification, a mean square error (MSE) is introduced, and calculated according to the formula
$$MSE = \frac{1}{N} {\sum }_{i = 1}^{N} {( {observed}_{i} - {predicted}_{i} )}^{2} ;$$
and
in the formula, N is the total number of morphological cracks of a same length, observed; is an actual value of each crack, and predicted; is a predicted value of each crack.

5. The method for pipeline defect detection, quantification, and evaluation based on CCTV and deep learning according to claim 4, wherein the pipeline crack severity grading rules in the step 5 are as follows: cracks are divided into four grades, including: Grade I cracks, with lengths within a range of 0-200 mm and/or widths within a range of 0-0.2 mm, wherein repair of the Grade I cracks is not required;
Grade II cracks, with lengths within a range of 200-300 mm and/or widths within a range of 0.2-2.0 mm, wherein the Grade II cracks are repaired through a trenchless repair method;
Grade III cracks, with lengths within a range of 300-400 mm and/or widths within a range of 2.0-5.0 mm, wherein the Grade III cracks are repaired through the trenchless repair method or a conventional excavation method;
Grade IV cracks, with lengths of >400 mm and/or widths of >5.0 mm, wherein pipeline replacement is required due to severity of the Grade IV cracks; and
when evaluation results indicate that a crack belongs to different grades classified by a length and a width thereof, the higher grade is regarded as the final grade determined.

6. An electronic device, comprising: a memory and a processor, wherein the memory is configured to store computer-executable instructions, the processor is configured to execute the computer-executable instructions, and when the computer-executable instructions are executed by the processor, steps of the method for pipeline defect detection, quantification, and evaluation based on CCTV and deep learning according to claim 5 are implemented.

7. A computer-readable storage medium, which stores computer-executable instructions, wherein when the computer-executable instructions are executed by the processor, steps of the method for pipeline defect detection, quantification, and evaluation based on CCTV and deep learning according to claim 5 are implemented.
